(19) United States
(12) Patent Application Publication
(10) Pub. No.: US 2010/0182746 A1
(43) Pub. Date: Jul. 22, 2010

(54) Thin notebook computer

(75) Inventors: Kun-Ho Lee, Taipei County (TW); I-Hao Chen, Taipei County (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 12/385,243

(22) Filed: Apr. 2, 2009

(30) Foreign Application Priority Data
Jan. 21, 2009 (TW) 98201188

(51) Int. Cl. G06F 1/16

(52) U.S. Cl. 361/679.55

(57) ABSTRACT

A thin notebook computer is disclosed, which includes a first casing, a second casing, a liquid crystal panel, and a cylinder battery. The liquid crystal panel is disposed close to a front side of the first casing. The second casing has a protruding portion facing the first casing, and the cylinder battery is disposed in the protruding portion. The protruding portion and the cylinder battery are arranged outside the liquid crystal panel and not disposed under the keyboard.

### RELATED APPLICATIONS

This application claims priority to Taiwan Application Serial Number 98201188, filed Jan. 21, 2009, which is herein incorporated by reference.

### BACKGROUND

1. Field of Invention

The present invention relates to a portable electronic device. More particularly, the present invention relates to a notebook computer

2. Description of Related Art

Due to rapid developments in electrical technologies and portable computer applications, notebook computers are gradually becoming smaller and lighter with each passing day. Notebooks with a portable outline size and weight create an enormous increase in processing speed, and therefore notebook computers have become a popular electrical product.

Refer to FIG. 1. FIG. 1 illustrates a conventional system stack arrangement of a notebook computer. The notebook computer 100 includes liquid crystal display (LCD) panel 110, a keyboard 120, a battery 130, a printed circuit board 140, and a connection port 150. The size of the LCD panel 110 determines the size of the notebook computer 100. The system stack arrangement determines the thickness of the notebook computer 100.

For example, the keyboard 120 is disposed under the LCD panel 110 in FIG. 1. The battery 130 and the printed circuit board 140 are disposed under the keyboard 120. The connection port 150 is also disposed under the keyboard 120.

The system stack arrangement disclosed in FIG. 1 is widely used in conventional notebook computers. The system stack arrangement would determine the thickness of the notebook computer. However, the conventional system stack arrangement, i.e. the keyboard is disposed under the LCD panel, and the battery, the printed circuit board, and the connection port are further disposed under the keyboard, is not easy to reduce the thickness of the notebook computer.

### SUMMARY

The invention provides a thin notebook computer, which includes a first casing, a second casing, a liquid crystal panel, and a cylinder battery. The liquid crystal panel is disposed close to a front side of the first casing. The second casing has a protruding portion facing the first casing, and the cylinder battery is disposed in the protruding portion. The protruding portion and the cylinder battery are arranged outside the liquid crystal panel and not disposed under the keyboard.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a conventional system stack arrangement of a notebook computer;

FIG. 2 illustrates a side view diagram of a first embodiment of the thin notebook computer of the invention;

FIG. 3 illustrates an oblique diagram in the second casing of a second embodiment of the thin notebook computer of the invention;

FIG. 4 illustrates a top view diagram of the second embodiment of the thin notebook computer of the invention; and

FIG. 5A and FIG. 5B illustrate side view diagrams from different directions of a third embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

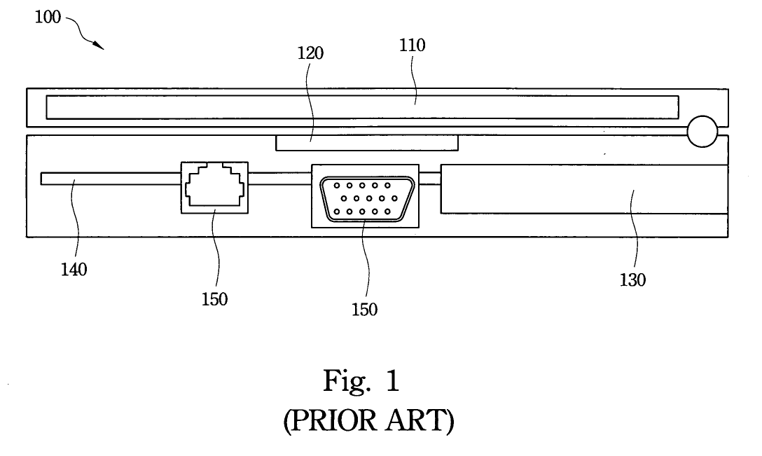

As described in FIG. 1, the conventional system stack arrangement of the notebook computer is not easy to reduce the thickness of the notebook computer, thus the thin notebook computer of the present invention provides a new system stack arrangement to reduce the thickness of the notebook computer.

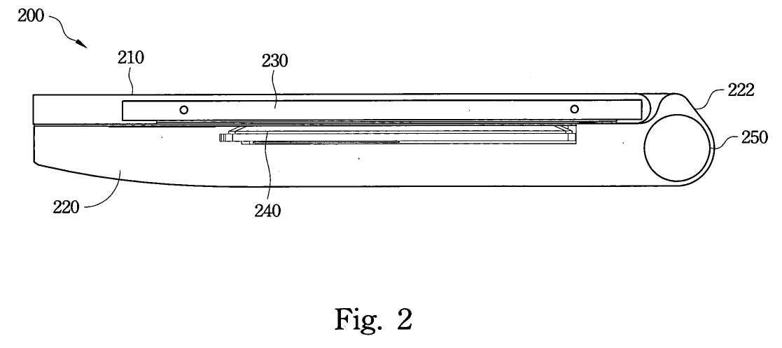

Refer to FIG. 2. FIG. 2 illustrates a side view diagram of a first embodiment of the thin notebook computer of the invention. The thin notebook computer 200 includes a first casing 210 and a second casing 220. The thin notebook computer 200 has a liquid crystal display (LCD) panel 230 disposed in the first casing 210. The thin notebook computer 200 has a keyboard 240 disposed in the second casing 220. The second casing 220 has a protruding portion 222 facing and protruding toward the first casing 210. The thin notebook computer 200 has a cylinder battery 250 disposed in the protruding portion 222 of the second casing 220. The protruding portion 222 and the cylinder battery 250 within are arranged outside of the LCD panel 230.

The LCD panel 230 is designed to set forward. The LCD panel 230 is arranged close to a front side of the first casing 210, thus the back side of the first casing 210 can be designed to arrange the protruding portion 222 of the second casing 220. The cylinder battery 250 arranged outside of the LCD panel 230 is also arranged upward to locate in the protruding portion 222. The length and the width of the thin notebook computer 200 need not to be extended in this embodiment. A part of the cylinder battery 250 is higher than the keyboard 240.

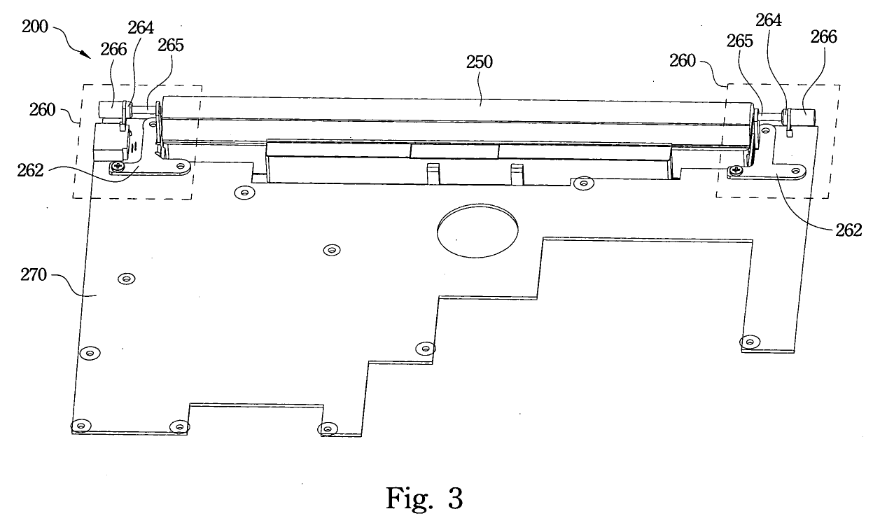

Refer to FIG. 3. FIG. 3 illustrates an oblique diagram in the second casing of a second embodiment of the thin notebook computer of the invention. The thin notebook computer 200 includes two connecting mechanisms 260. The connecting mechanisms 260 are disposed at two opposite sides of the cylinder battery 250. The connecting mechanisms 260 are disposed in the protruding portion (not shown). The thin notebook computer 200 includes a printed circuit board 270. The printed circuit board 270 is disposed in the second casing (not shown). Each connecting mechanism 260 has a fixing portion 262. The fixing portion 262 is fixed on the printed circuit board 270 to improve the structure strength of the connecting mechanism 260.

Each connecting mechanism 260 has a hinge 264. The hinge 264 has a first end 265 and a second end 266. The first end 265 is the end close to the cylinder battery 250, and the second end 266 is the end opposite to the cylinder battery 250. The radius of the first end 265 is smaller than the radius of the second end 266.

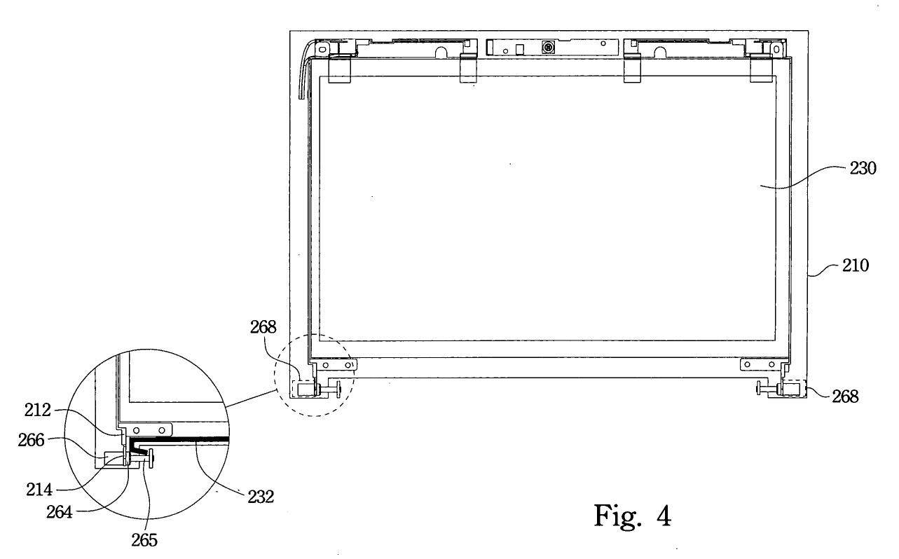

Refer to FIG. 4. FIG. 4 illustrates a top view diagram of the second embodiment of the thin notebook computer of the invention. The first casing 210 has a bracket 212 to fix the LCD panel 230. The bracket 212 has two openings 214 for coupling to the hinges 264 respectively, thus the first casing 210 is connected to the second casing 220. The first casing 210 can be lifted from the second casing (not shown) or closed by the hinge 264.

The LCD panel 230 in the first casing 210 must communicate to the components in the second casing for operating. The radius of the first end 265 is smaller than the radius of the second end 266. The openings 214 of the bracket 212 are coupled to the second ends 266 of the hinges 264 respectively. The LCD panel 230 has at least one transmission line 232 for transmitting image signals. The transmission line 232 can enter to the second casing via the first end 265 easily, which has the smaller radius.

Each connecting mechanism has a torsion generator 268. The torsion generator 268 is disposed at the second end 266 of the hinge 264 to provide the friction force for positioning the first casing 210 and the second casing. The torsion generator 268 can be an O-ring, an elastic piece, or a cam.

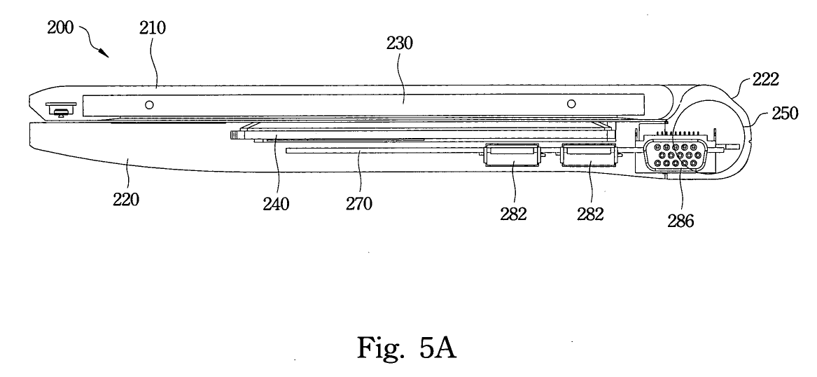

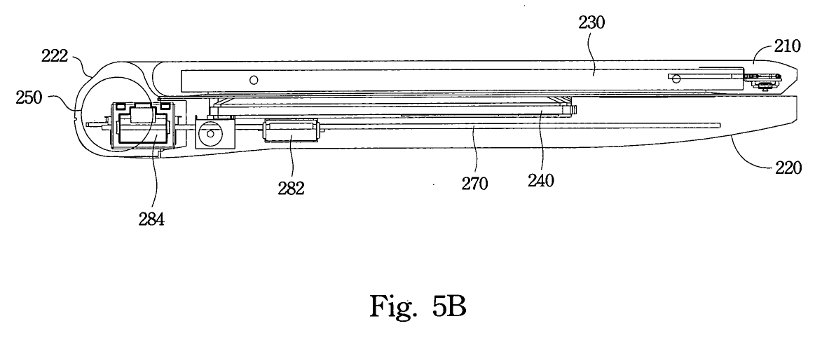

Refer to FIG. 5A and FIG. 5B. FIG. 5A and FIG. 5B illustrate side view diagrams from different directions of a third embodiment of the invention. The LCD panel 230 is disposed in the first casing 210. The keyboard 240, the cylinder battery 250, and the printed circuit board 270 are disposed in the second casing 220. The thin notebook computer 200 further includes several connection ports, such as a universal serial bus (USB) port 282, a RJ45 port 284, or a video graphics array (VGA) port 286. The USB port 282 can be disposed under the keyboard 240.

The RJ45 port 284 and the VGA port 286 are the components having high thickness. The RJ45 port 284, the VGA port 286, or other high-thickness components can be disposed at two opposite sides of the cylinder battery 250, which is disposed in the protruding portion 222 of the second casing 220. Unlike the conventional system stack arrangement, which arranges the high-thickness components under the keyboard 240, the high-thickness components in this embodiment are disposed next to the cylinder battery 250 and arranged outside of the keyboard 240. The high-thickness components are not disposed under the keyboard 240, thus the thickness of the thin notebook computer 200 is reduced.

The width of the VGA port 286 is reduced to fit the width of the cylinder battery 250. For example, the cylinder battery 250 in this embodiment is an 18650 Li battery, and the diameter of the cylinder battery 250 with a plastic casing is about 21 mm. The width of the conventional VGA port is about 31 mm, but the width of the VGA port 286 in this embodiment is cut to 20.5 mm.

The LCD panel in the present invention is disposed close to the front side of the first casing, thus the protrusion portion and the cylinder battery within can be arranged outside of the LCD panel and the length of the thin notebook computer need not to be increased. The cylinder battery is disposed outside of the keyboard and is not disposed under the keyboard, thus the thickness of the thin notebook computer of the present invention is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A thin notebook computer comprising:
a first casing;
a second casing having a protruding portion arranged facing the first casing;
a liquid crystal display panel disposed in the first casing and arranged close to a front side of the first casing;
a cylinder battery disposed in the protruding portion of the second casing, wherein the protruding portion and the cylinder battery within are arranged outside of the liquid crystal display panel;
a plurality of high-thickness components disposed in the protruding portion and arranged at opposite ends of the cylinder battery; and
a plurality of connecting mechanisms disposed in the protruding portion for connecting the first casing and the second casing.

2. The thin notebook computer of claim 1, wherein the plurality of connecting mechanisms are disposed at two opposite sides of the cylinder battery.

3. The thin notebook computer of claim 2, wherein the thin notebook computer comprises a printed circuit board disposed in the second casing, and each connecting mechanism comprises a fixing portion fixed on the printed circuit board.

4. The thin notebook computer of claim 2, wherein each connecting mechanism comprises a hinge, and the first casing comprising two openings coupling to the hinges respectively.

5. The thin notebook computer of claim 4, wherein each connecting mechanism comprises a first end and a second end, and a radius of the first end is smaller than a radius of the second end.

6. The thin notebook computer of claim 5, wherein the liquid crystal display panel comprises at least one transmission line entering to the second casing via the first end of the hinges.

7. The thin notebook computer of claim 5, wherein the openings are coupling to the second ends.

8. The thin notebook computer of claim 5, wherein each connecting mechanism comprises a torsion generator disposed at the second end of the each hinge.

9. (canceled)

10. The thin notebook computer of claim 1, wherein the high-thickness components comprise a video graphics array (VGA) port or a RJ45 port.

11. The thin notebook computer of claim 1, further comprising a keyboard disposed in the second casing, wherein the high-thickness components are arranged at a side of the keyboard.

12. The thin notebook computer of claim 11, wherein a part of the cylinder battery is higher than the keyboard.
